(19) United States
(12) Patent Application Publication
(10) Pub. No.: US 2008/0234953 A1
(43) Pub. Date: Sep. 25, 2008

(54) Power estimation for a semiconductor device

(76) Inventors: James S. Ignowski, Fort Collins, CO (US); Chris Bostak, Fort Collins, CO (US); Warren H. Parks, Fort Collins, CO (US)

Correspondence Address: INTEL CORPORATION;c/o INTELLEVATE, LLC, P.O. BOX 52050, MINNEAPOLIS, MN, 55402, US

(21) Appl. No.: 11/726,819

(22) Filed: Mar. 22, 2007

(51) Int. Cl. G06F 19/00

(52) U.S. Cl. 702/60

(57) ABSTRACT

Disclosed herein are different embodiments for estimating and/or controlling power consumption in a chip based on hot and cool temperatures in the chip.

### BACKGROUND

In various semiconductor applications, it is becoming advantageous to be able to monitor the amount of power that a chip (or portion of a chip) is consuming. For example, in some applications, maximum power consumption requirements may be imposed but at the same time, it may be desirable to operate as close as possible to such maximum requirements in order to achieve improved performance. Existing power consumption monitoring (and/or estimation) approaches involve measuring voltages and/or currents and then calculating power consumption, but unfortunately, such approaches can be relatively costly, e.g., in terms of circuit or manufacturing resources to implement them. Accordingly, a novel approach for monitoring power consumption is desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a side view of a semiconductor device with temperature sensors to estimate power consumption in accordance with some embodiments.

FIG. 2 is a flow diagram showing a method to estimate power consumption in the semiconductor device of FIG. 1 in accordance with some embodiments.

FIG. 3 is a block diagram showing a power estimation system for a multi-core processor in accordance with some embodiments.

FIG. 4 is a flow diagram showing a routine for estimating power consumption in the processor of FIG. 3.

FIG. 5 is a block diagram of a computer system having a processor chip with a power estimation system in accordance with some embodiments.

### DETAILED DESCRIPTION

As taught herein, the basic idea of this disclosure is that integrated circuit junction temperature (Tj) can be used to estimate the chip's power dissipation. It is generally known that:

Tⱼ₍ₕₒₜ₎=Ψ_{j-c}·P+T_{case}.

Tⱼ(hot) is the temperature (in ° C.) of a hot portion (e.g., hottest or reasonably approaching the hottest) portion in an operating semiconductor device; Ψ_{j-c} is the thermal resistance, from junction-to-case, for the semiconductor device; P is the consumed power of the device; and T_{case} is the temperature of the semiconductor case. (As used herein, the case corresponds to the exterior of the semiconductor chip, typically, one or more surfaces used to conduct heat away from the chip. For example, it could correspond to the temperature of a heat spreader thermally mounted to a chip.)

It has been observed, especially for relatively large chips such as multi-core processor chips, that the case temperature (T_{case}) is typically reasonably proximal to “cool” areas within an operating chip. Thus, with the equation above, T_{j(cool)} can be substituted for T_{case}. Thus, with this substitution, P can be derived as:

P≈(Tⱼ₍ₕₒₜ₎−T_{j(cool)})/Ψ_{j-c}.

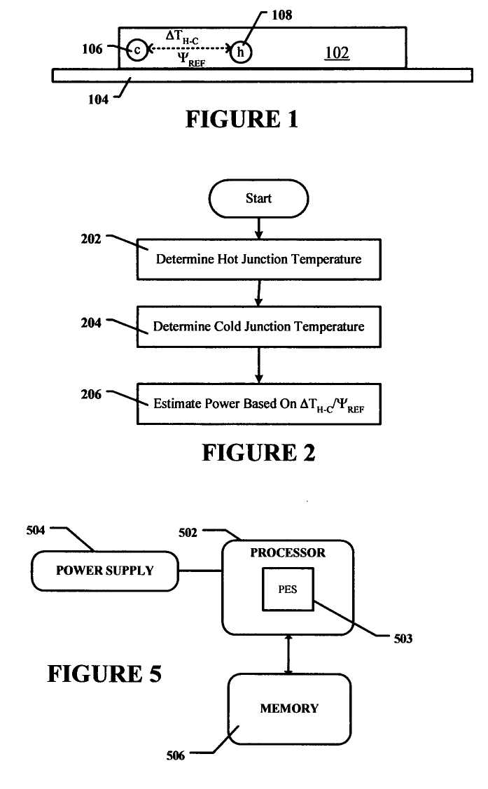

With reference to FIG. 1, this approximation can be used to estimate power consumption in a semiconductor chip as it is being operated. FIG. 1 shows a side view of a chip (e.g., Silicon chip) 102 thermally coupled to a heat spreader 104. (this is not drawn to scale and does not include all elements of an integrated circuit package.) The chip 102 may be any type of chip including but not limited to a system on a chip (SOC), microcontroller, multi-core processor, application specific integrated circuit (ASIC) or the like. It is noted, however, that it has been observed that the the power estimation methods disclosed herein generally are more accurate with larger and/or higher power consuming chips.

The semiconductor chip 102 has a temperature sensor circuit 106 for determining a relatively cool temperature of the chip and a temperature sensor circuit 108 for determining a relatively hot temperature of the chip. It also has logic (not shown) to receive signals from the sensors to calculate an estimated power, consumed by the chip, using the above approximation. (Note that in some embodiments, it may not be necessary to actually divide by a thermal resistance. that is, the thermal resistance is a constant, so the hot/cool temperature difference could be used, e.g., to control or limit power consumption, without having to calculate an actual power value.)

Any suitable temperature sensing circuit may be used to implement sensors 106 or 108. There are varieties of different types of temperature sensing circuits known to persons of skill in the art. For example, suitable temperature sensing circuits and schemes are shown in U.S. Pat. App. Publ. No. 20060265174 to Doyle et al., entitled “THERMAL SENSING FOR INTEGRATED CIRCUITS” and incorporated by reference herein.

Logic (not shown) for processing temperature sensor signals and determining a power estimate using the above formula may be implemented with any suitable circuitry within the chip. For example, it could be performed with firmware instructions in an on-board controller, or it could be performed with dedicated circuitry such as circuit components to implement a finite state machine.

The sensors 106, 108 may be located in any areas of the chip sufficient for achieving acceptably accurate power consumption estimations. For example, as shown in the figure, the hot sensor 108 is located relatively centrally, e.g., within a processor's core, where operating temperature may be the highest. In contrast, the cool sensor is located in an outer area of the chip, which may be the coolest part of the chip and reasonably close to the temperature of the heat spreader 104. It should be appreciated, however, that the hottest or coolest locations are not required for estimating power, but in some embodiments, they may yield the most accurate results.

(Along these lines, it should be appreciated that as used herein, the terms “hot” and “cool” are relative terms and should not be limited to any specific range of temperatures. They are used to indicate a relationship between temperatures, e.g., a hot temperature is higher than a cool temperature and vice versa. For example, a reading of 100° C. could be “cool” in comparison with other higher temperatures. by the same token, 20° C. could be “hot” in comparison with other cooler temperatures.)

In some embodiments, junction-to-case thermal resistance (Ψ_{j-c}) may be used for the power estimation. This may be convenient in that it may already be available. Alternatively, a different thermal resistance value, particularly corresponding to the thermal gradient between the hot and cool temperature sensors, could be used. It could be determined through characterization using a sufficient number of chips with actual power consumption being measured so that a Ψ_{h-c} for the chip type can be obtained.

FIG. 2 generally shows a routine to estimate power in a chip such as the chip of FIG. 1. Initially, at 202, the hot temperature from sensor 108 is determined. Next, at 204, the cool temperature is determined from sensor 106. Finally, at 206, an estimate of the power being consumed is derived by determining the difference between the hot and cool temperatures and dividing the result by Ψ.

Depending on the type of chip, its application, and complexity, the estimated power may be used for a variety of purposes. In some embodiments, it may be accurate enough to actually control how hard a chip is driven in order to operate it at (or close to) its maximum rated power. In other applications, it may be used as a secondary power monitoring scheme, e.g., as a failsafe, in addition to another more accurate scheme. In other applications, it could, for example, be used in cooperation with a power conservation mode in a mobile device.

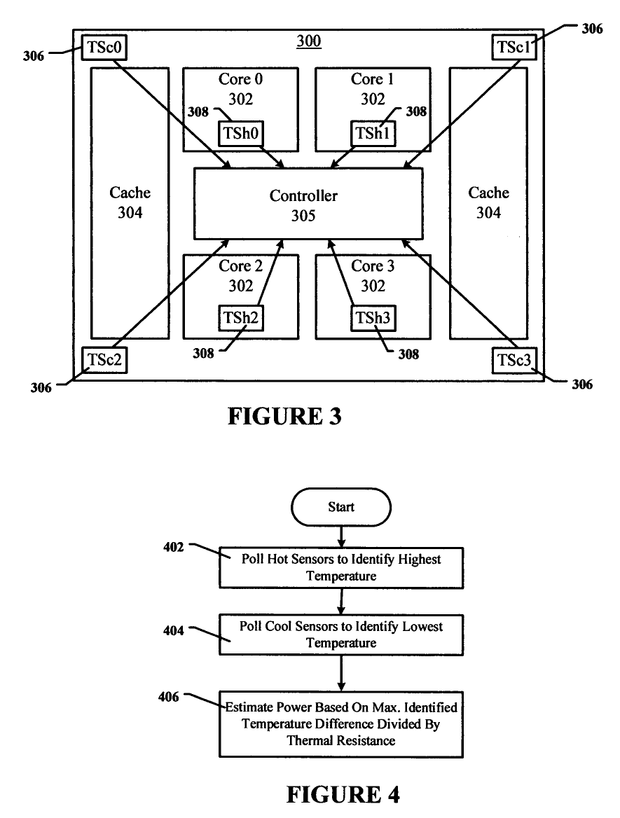

FIG. 3 shows a block diagram of a multi-core processor chip 300 with a power estimation system. It comprises cores 302 (Core 0 to Core 3), cache blocks 304, and a controller 305 to administer operation of the cores, among other things. It also comprises four temperature sensors 306 (TSc0 to TSc3) for determining cool temperatures and four temperature sensors 308 (TSh0 to TSh3) for determining hot temperatures. They are each coupled to the controller 305 so that it can receive signals indicative of their temperatures in order to estimate power consumption in the chip 300. (Note that with a multi-core processor, power estimation may be performed on a per-core basis using the hot spot of each core. By calculating power for each hot spot (e.g., in each core), relative per-core power can be estimated, allowing, in some applications, for a more accurate full chip total power estimation, as well for assisting in load balance between cores, etc.)

The cores are relatively centrally located with the cache 304 located in outer areas of the chip. As seen in the figure, the cool sensors 306 are located near the outer corners, away from the cores and closer to the cache, which typically have the cooler portions of the chip. Conversely, the hot sensors 308 are located in the cores, which typically have the hotter areas of the chip.

FIG. 4 shows a routine for estimating power consumption in the multi-core chip 302 of FIG. 3. In this embodiment, the routine is performed by controller 305. Initially, at 402, it polls the hot temperature sensors 308 to identify the highest measured temperature in the chip. At 404, it polls the cool sensors 306 to identify the coolest measured temperature. (These tasks could be done in any order.) At 406, it calculates an estimation of the consumed power by finding the difference between the highest and lowest measured temperatures and then dividing this difference by a thermal resistance Ψ.

The utilized Ψ could be a single thermal resistance for the chip (e.g., a junction-to-case Ψ or a different, specifically characterized point-to-point Ψ within the chip). Alternatively, it could be selected from a group of thermal resistance values Ψ characterized for each hot sensor to cool sensor gradient combination.

FIG. 5 shows an example of a computer system with a power estimation system such as the one of FIG. 3. It generally comprises a multi-core processor chip 502 that is coupled to a power supply 504 and to external memory 506. (It also may be coupled to a plurality of clients via a network interface, not shown.) It is coupled to the power supply 504 to receive from it power when in operation, and it is coupled to memory 506 for additional random access memory storage. The processor 502 has a power estimation system (PES) 503, such as that disclosed in FIG. 3, to estimate power consumption in the chip 502. In some embodiments, it may be used as a back-up to avoid an “over-power” condition.

It should be noted that the depicted system could be implemented in different forms. That is, it could be implemented in a single chip module, a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

Moreover, it should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the figures for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
two or more temperature sensor circuits to provide hot and cool temperature information for an estimation of chip power consumption.

2. The chip of claim 1, in which a first one of the two or more thermal sensors is to sense a cool temperature and is positioned in an outer area of the chip.

3. The chip of claim 1, in which the two or more sensors provide analog signals indicative of their temperatures.

4. The chip of claim 1, comprising a controller coupled to the two or more sensors to receive the information and to calculate the power estimation.

5. The chip of claim 4, in which the controller is to generate the power estimation by generating a difference between the hot and cool temperatures and dividing the difference by a thermal resistance value associated with the chip.

6. The chip of claim 5, in which the thermal resistance value is a junction to case value.

7. The chip of claim 5, in which the thermal resistance value is derived from characterization of a plurality of chips.

8. The chip of claim 1, in which the two or more temperature sensors comprise two or more sensor circuits to provide hot temperature information and two or more sensor circuits to provide cool temperature information.

9. The chip of claim 1, in which the power estimation is to be determined based on the hottest and coolest temperatures received from the sensor circuits.

10. A chip comprising:
a plurality of processor cores with at least one hot temperature sensor to provide hot temperature information;
at least one cool temperature sensor to provide cool temperature information; and
circuitry to receive the hot and cool temperature information to affect power consumption in the chip based on a difference between said hot and cool temperature information.

11. The chip of claim 10, in which the circuitry forms at least part of a controller.

12. The chip of claim 11, in which the controller has associated instructions to cause it to poll the hot sensors and at least one cool sensor to identify hottest and coolest temperatures to determine the temperature information difference.

13. The chip of claim 11, in which the controller is to determine a power estimation.

14. The chip of claim 13, in which the controller is to divide the derived temperature information difference by a thermal resistance value derived from an associated thermal resistance characterization of the chip.

15. The chip of claim 13, in which the controller is to divide the temperature information difference by a thermal resistance value associated with selected hot and cool temperatures.

16. The chip of claim 10, in which the at least one cool temperature sensor is in an outer area of the chip.

17. The chip of claim 16 in combination with a power supply and one or more memory chips as part of a computer system.

18. A method, comprising:
determining a hot temperature in a chip;
determining a cool temperature in the chip; and
estimating power consumption for the chip based on the determined hot and cool temperatures.

19. The method of claim 18, in which the power consumption is estimated by calculating the difference between the hot and cool temperatures and dividing the difference by a thermal resistance value associated with the chip.

20. The method of claim 18, in which the cool temperature is determined by identifying the coolest temperature from a plurality of different temperature sensors that are part of the chip.

21. The method of claim 20, in which the hot temperature is determined by identifying the hottest temperature from a plurality of different temperature sensors that are part of the chip.

22. The method of claim 18, comprising regulating power consumption of the chip based on the estimated power consumption.
